(19) United States
(12) Patent Application Publication
(10) Pub. No.: US 2026/0000047 A1
(43) Pub. Date: Jan. 1, 2026

(54) LITTER SCOOP

(71) Applicant: Curtis Taylor, Chagrin Falls, OH (US)

(72) Inventor: Curtis Taylor, Chagrin Falls, OH (US)

(21) Appl. No.: 19/094,092

(22) Filed: Mar. 28, 2025

Related U.S. Application Data
(60) Provisional application No. 63/666,408, filed on Jul. 1, 2024.

(51) Int. Cl. A01K 1/01

(52) U.S. Cl. CPC A01K 1/0116

(57) ABSTRACT

A litter scoop having either a wire configuration or a mesh configuration that enables materials collected by the litter scoop and to conveniently separate clumped cat litter from unclumped cat litter or cat litter that is clumped at a small size.

### REFERENCED APPLICATION

This application claims priority to U.S. Provisional Patent Application No. 63/666,408 filed Jul. 1, 2024.

### I. BACKGROUND

### Technical Field

The present disclosure is directed to a litter scoop having a configuration that enables materials collected by the litter scoop and to conveniently separate clumped cat litter from unclumped cat litter or cat litter that is clumped at a small size.

### Description of Related Art

Many different types of sifting devices, including mesh screens, have been used in the past for the purpose of sifting through and separating one material from another. Generally, these mesh screens contain openings for allowing one material (with smaller particle size) to pass through the screen while the other material (with larger particle size) is to be retained by the screen.

One type of material that regularly needs sifting is pet litter. Pet litter comes in many different formulations configured to absorb excrement, including urine and fecal matter, in a manner that reduces odor, minimizes animal contact, and facilitates disposal. Pet litter is made of a mixture of varying sized particles that typically have a maximum width or diameter of about two or three millimeters. Commercially available litters include clumping litters made of granulated bentonite, such as calcium bentonite, quartz-bentonite mixture, or silica-based litters made of a silica gel or silica crystal.

Pet waste scoops, also referred to as litter scoops, have long been used to sift pet litter to separate pet waste containing fecal matter and litter that has absorbed excrement from unspent litter. Many configurations of litter scoops are available and all require that the litter be scooped in a retaining pan portion of the litter scoop and then the litter scoop is turned sideways or pivoted forwardly to dump the contents from the pan portion. As the pan portion fills with contents, it must be constantly emptied since the contents will generally move off the pan portion when attempting to scoop other material from the litter box.

In view of the prior art, there remains a need for a litter scoop that can easily and conveniently be used to separate contaminated from uncontaminated material, and which pan can be used to easily and conveniently separate waste material (e.g., pet refuse, urine clumps, etc.) from uncontaminated litter in a litter box.

### II. DETAILED DESCRIPTION

The present disclosure is directed to a litter scoop that has a mesh scoop portion having a plurality of openings to allow unclumped pet litter to pass therethrough and wherein the size of the plurality of openings can be controlled by the user to control the amount and size of scooped pet litter that is retained by the scoop portion of the litter scoop.

FIGS. 1-3 illustrate one non-limiting embodiment of the litter scoop in accordance with the present disclosure.

FIGS. 4-6 illustrate a second non-limiting embodiment of the litter scoop in accordance with the present disclosure.

FIGS. 7-9 illustrate a third non-limiting embodiment of the litter scoop in accordance with the present disclosure.

Referring now to FIGS. 1-3, there is illustrated a litter scoop that includes a main portion as illustrated in FIG. 2 and a secondary portion that is illustrated in FIG. 3. FIG. 1 illustrates the secondary portion fully connected to the main portion. The main portion includes a handle portion 10 that is configured to enable a user to grasp and use the litter scoop. The rear end region of the handle portion can optionally include a handle opening 12 that is configured to enable the litter scoop to be hung on a hook, peg, etc. The size, configuration and/or material of the is non-limiting. In some embodiments, the main and secondary scoop portions may be wire or alternatively molded plastic. The handle portion can optionally include gripping regions 50 as shown in FIG. 7 to facilitate in the gripping and grasping of the handle portion by a user. The main portion also includes a scoop portion 30 that is connected to the front end of the handle portion 10. The scoop portion can be permanently or detachably connected to the handle portion. The scoop portion includes a plurality of openings 40 that are configured to allow unclumped pet litter to pass through the plurality of openings when a user is using the litter scoop to removed clumped pet litter from a litter box or other container that contains clumped pet litter. The number, size and/or shape of the openings in the scoop portion is non-limiting. The material user to form the scoop portion is non-limiting. As illustrated in FIG. 2, the scoop portion 30 has a plurality of openings on the bottom, sides and rear of the scoop portion; however, this is not required. In one non-limiting arrangement, the scoop portion include a plurality of openings that are positioned generally parallel to one another along the base of the scoop portion. Two or more of such openings optionally have the same or similar width that is generally constant along the longitudinal length of one or more of the openings. In another non-limiting arrangement, two or more of the bottom openings optionally have a variable width along the longitudinal length of the side openings. In another non-limiting arrangement, two or more of the side openings optionally have a variable width along the longitudinal length of the side openings. In another non-limiting arrangement, two or more of the side openings optionally have a constant width along the longitudinal length of the side openings. In another non-limiting arrangement, two or more of the rear openings optionally have a constant width along the longitudinal length of the side openings. In another non-limiting arrangement, two or more of the rear openings optionally have a variable width along the longitudinal length of the side openings. In another non-limiting arrangement, the scoop portion is optionally formed of a plurality of interconnected wires (e.g., plastic wires, metal wires, etc.). As illustrated in FIG. 2, the rear region of the scoop portion has a greater depth than the front region of the scoop portion. As also illustrated in FIG. 2, the rear region of the scoop portion optionally has a curved profile; however, this is not required.

Referring now to FIG. 3, the secondary portion is configured to connect to the scoop portion of the main portion of the litter scoop and reduce the size of one or more of the openings 70 in litter scoop when the secondary portion is fully connected to the main portion. As illustrated in FIG. 3, the secondary portion includes a body that has a plurality of openings 40. Two or more of the openings can optionally have the same width along the longitudinal length of the openings. Two or more of the openings can optionally have a variable width along the longitudinal length of the openings. The number of openings in the body of the secondary portion can be less, the same or more than the number of openings in the bottom of the scoop portion of the main portion. As illustrated in FIGS. 1-3, the number of openings in the body of the secondary portion is less than the number of openings in the bottom of the scoop portion of the main portion. The rear region of the secondary portion optionally has a curved profile that is similar to the curved profile of the rear region of the scoop portion of the main portion. In another non-limiting arrangement, the secondary portion is optionally formed of a plurality of interconnecting wires (e.g., plastic wires, metal wires, etc.).

Referring now to FIGS. 1 and 3, the front region of the secondary portion includes one or more hooks 90 or other type of arrangement that enables the front region to be pivotally or hingably connected to the front region of the scoop portion of the main portion as illustrated in FIG. 1. The one or more hooks or other type of arrangement can be configured to permanently or releasably connect the front region of the secondary portion to the front region of the scoop portion of the main portion. The rear region of the secondary portion includes one or more grasping handles or latches 100 that are configured to a) enable a user to pull the rear region of the secondary portion up against the rear region of the scoop portion of the main portion, b) enable a user to push the rear region of the secondary portion away from the scoop portion of the main portion, and/or c) releasably connect the rear region of the secondary portion to the rear region of the scoop portion of the main portion when the secondary portion is fully connected to the main portion.

Referring now to FIG. 1, when the secondary portion is fully connected to the main portion, one or more of the wires 30 of the secondary portion are positioned between the wires of the scoop portion of the main portion thereby reducing the size of the openings 70 in one or more regions of the bottom of the litter scoop. As also illustrated in FIG. 1, when the secondary portion is fully connected to the main portion, one or more of the wires 30 of the secondary portion are positioned between the wires 30 of the scoop portion of the main portion thereby reducing the size of the openings 70 in one or more regions of the rear of the litter scoop.

In operation, the user uses the main portion of the scoop as illustrated in FIG. 2 to scoop up larger clumps pet litter from a litter box during the cleaning of the litter box. If the user determines that the litter box requires further cleaning since smaller clumps of litter passed through the openings in the main portion of the scoop, the user attaches the secondary portion to the main portion as illustrated in FIG. 1 to capture and remove smaller clumps of pet litter from a litter box. The litter scoop as illustrated in FIGS. 1-3 allows a user to remove different sized clumps of pet litter from a litter box as desired. As can be appreciated, the litter scoop as illustrated in FIGS. 1-3 can be configured for use with removal of waste material (e.g., general refuse [e.g., dust, dirt, leaves, dropped or spilled food, broken glass, fur balls, etc.], pet refuse, urine clumps, etc.) from a litter box, the ground, etc. and will be described with particular reference thereto; however, it can be appreciated that the litter scoop of the present disclosure can be used in the collection and/or sifting of other particulate objects (e.g., sand, dirt, debris, etc.). The litter scoop as illustrated in FIGS. 1-3 is suitable for use with the collection, sifting, and disposing of pet refuse, urine clumps, etc. from a litter box.

Referring now to FIGS. 4-6, there is illustrated a second non-limiting embodiment of the litter scoop in accordance with the present disclosure. The litter scoop 120 is equipped with a spring-loaded trigger mechanism that is used to adjust the size of the mesh openings 70 in the bottom of the litter scoop so as to control the size of the pet litter clumps in the litter scoop during the cleaning of a litter box. By integrating a mesh design with a spring-loaded trigger, the litter scoop provides an efficient, user-friendly solution that minimizes effort and maximizes effectiveness in separating clean pet litter or unclumped pet litter from clumped pet litter.

The litter scoop with a spring-loaded trigger mechanism 130 is specifically engineered to enhance the user experience and improve the efficiency of litter box maintenance. Traditional scoops often require manual shaking and sifting, which can be physically demanding and time-consuming. The mesh design of the litter scoop ensures that clean litter falls back into the litter box, while larger sized waste clumps are retained, making the cleaning process quick and efficient. The trigger mechanism can be used to adjust the size of the mesh openings to control the size of clumped pet litter that is retained in the litter scoop.

The handle 10 of the litter scoop is ergonomically designed to provide a comfortable and secure grip, reducing strain on the user's hand and wrist during use. The spring-loaded trigger mechanism is integrated into the handle, allowing the user to control the mesh opening size with a simple squeeze of the trigger. The spring-loaded trigger mechanism includes a trigger, a spring, and a linkage system that connects the trigger to a movable mesh in the scoop body.

The litter scoop is constructed from durable and lightweight materials such as high-strength plastic or metal. The litter scoop is configured to withstand repeated use without compromising performance. The mesh design of the litter scoop has openings that are sized to allow clean litter to pass through mesh while retaining clumped pet litter.

Referring again to FIGS. 4-6, the litter scoop 120 includes a top mesh frame that is movable relative to a bottom mesh frame. A handle 10 is permanently or releasably connected to a rear region of the bottom mesh frame. The base portion of the bottom mesh frame includes a plurality of openings 70. The base portion of the bottom mesh frame can be formed of a plurality of interconnected and/or overlapping wires (e.g., metal wires, plastic wires, etc.). The number of openings in the bottom mesh frame is non-limiting. The size of a plurality of openings in bottom mesh frame can be the same or different. The height of the rear portion of the bottom mesh frame can be optionally greater than the height of the front portion of the bottom mesh frame. The height of the sides of the bottom mesh frame can optionally vary along the longitudinal length of the bottom mesh frame. The sides of the bottom mesh frame can optionally include one or more side openings. The front region of the bottom mesh frame can optionally include a lip portion 150 that can facilitates in scooping pet litter into the litter scoop during use. The size and/or configuration of the lip portion, when used, is non-limiting. The frame of the bottom mesh frame, other than the portion forms the bottom openings, can be formed of durable materials (e.g., plastic, metal, ceramic, etc.).

The top mesh frame that is movable relative to a bottom mesh frame includes has a base portion that includes a plurality of openings. The base portion of the top mesh frame can be formed of a plurality of interconnected and/or overlapping wires (e.g., metal wires, plastic wires, etc.). The number of openings in the top mesh frame is non-limiting. The size of a plurality of openings in top mesh frame can be the same or different. The size and/or number of a plurality of openings in top mesh frame can be the same or different as the size and/or number of a plurality of openings in bottom mesh frame. The height of the rear portion of the top mesh frame can be optionally greater than the height of the front portion of the top mesh frame. The height of the sides of the top mesh frame can optionally vary along the longitudinal length of the top mesh frame. The sides of the top mesh frame can optionally include one or more side openings. The one or more openings in the sides of the top mesh frame can be configured to align or be unaligned with at least a portion of the one or more openings in the sides of the bottom mesh frame when the top mesh frame is moved relative to the bottom mesh frame as illustrated in FIGS. 4-6. The front region of the top mesh frame can optionally include a lip portion. The frame of the top mesh frame, other than the portion forms the bottom openings, can be formed of durable materials (e.g., plastic, metal, ceramic, etc.).

The spring-loaded trigger mechanism 130 is configured to cause the top mesh frame to move relative to the bottom mesh frame. As illustrated in FIG. 4, the spring-loaded trigger mechanism has not been pulled by a user, thus the top mesh frame is in the forward position. As illustrated in FIG. 4, the size of the openings through bottom the pet scoop is smaller than when the top mesh frame is in the rearward position as illustrated in FIGS. 5-6. When the trigger is pulled, the top mesh frame moves rearwardly and the openings in the top and bottom mesh frames align, thereby making the openings through the bottom of the pet scoop larger. As such, a user can control the size of the openings in the bottom of the litter scoop during user to control the size of clumped and/or unclumped pet litter that is retained in the litter scoop during use.

Referring now to FIGS. 7-9, a third embodiment may replace the trigger mechanism 130 on the underside of the handle 10 with an actuatable sliding trigger 180 that can be engaged to protract or withdraw the secondary scoop within the shell of the primary scoop to adjust the size of the holes 70 in the scoop as dictated by the desired size of screening for litter scooping. The sliding trigger 180 may include a depression 190 to receive a finger from the operator so as to aid with grip when actuating the trigger. The scoop may optionally include front chamfers 210 and the sides of the scoop may include side chamfers 220 to aid the operator in drawing litter and waste into the scoop without physically deforming the litter or waste as may occur with a blunt edge. These chamfers may be included on both the primary (outer) and secondary (inner) scoops. FIG. 7 depicts a top-view of the assembled sliding trigger embodiment of the scoop device. In some embodiments, the front edge of the outer scoop may contain a series of holes to allow the user of the scoop to filter litter without filling the entire scoop.

### III. DISCLAIMERS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function. The singular forms “a,” “an,” and “the” include plural referents unless the context clearly dictates otherwise.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

One or more implementations of the subject application will now be described with reference to the attached figures, wherein like reference numerals are used to refer to like elements throughout. Referring now to the drawings wherein the showing is for the purpose of illustrating non-limiting embodiments of the disclosure only and not for the purpose of limiting the same, FIGS. 1-6 illustrate non-limiting embodiments of a litter scoop in accordance with the present disclosure.

The description of embodiments and examples has been presented for purposes of illustration and description. It is not intended to be exhaustive or limiting to the forms described. Numerous modifications are possible in light of the teachings herein. Some of those modifications have been discussed, and others will be understood by those skilled in the art. The embodiments were chosen and described in order to illustrate principles of various embodiments as are suited to particular uses contemplated. The scope is, of course, not limited to the examples set forth herein, but can be employed in any number of applications and equivalent devices by those of ordinary skill in the art.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the preferred embodiments. These and other modifications of the preferred embodiments as well as other embodiments of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

### IV. BRIEF DESCRIPTION OF THE DRAWINGS

FIG. 1 shows an assembled scoop with both the top and bottom mesh frames with the attached handle.

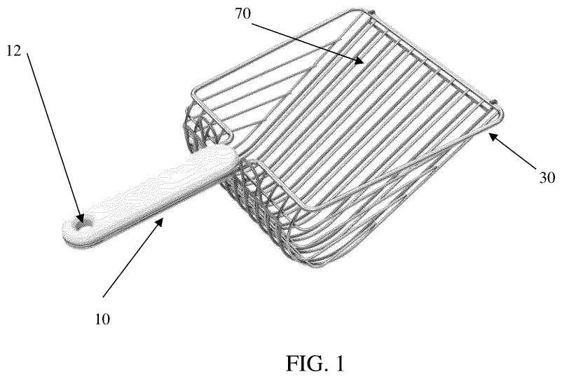

FIG. 2 shows a top mesh frame with attached handle.

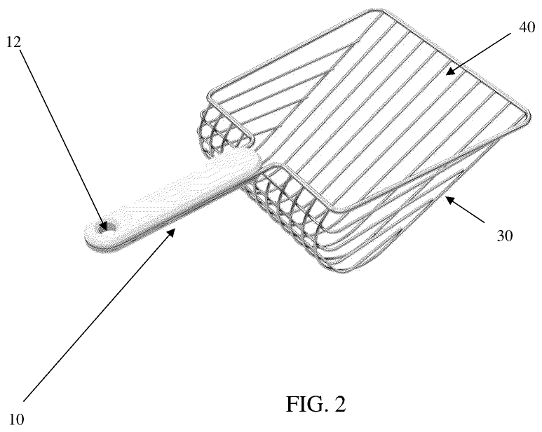

FIG. 3 shows a bottom mesh frame.

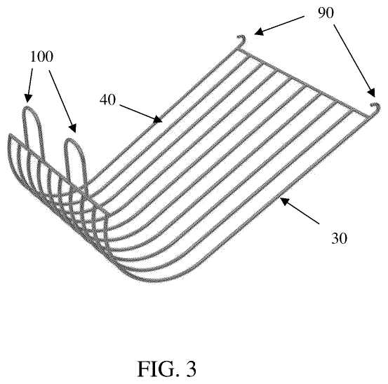

FIG. 4 shows an assembled scoop with both the top and bottom mesh frames with the top mesh frame attached to a spring-loaded trigger mechanism in the forward position.

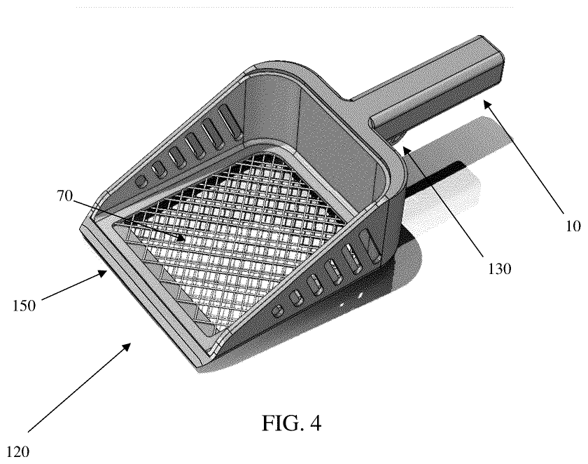

FIG. 5 shows an assembled scoop with both the top and bottom mesh frames with the top mesh frame attached to a spring-loaded trigger mechanism in the rearward position.

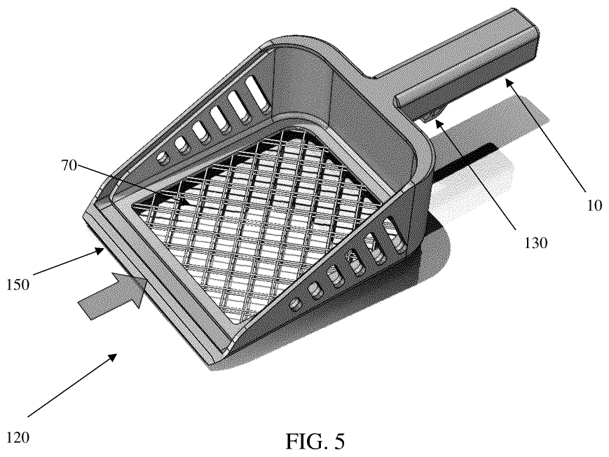

FIG. 6 shows the underside of the top mesh frame with attached spring-loaded trigger mechanism.

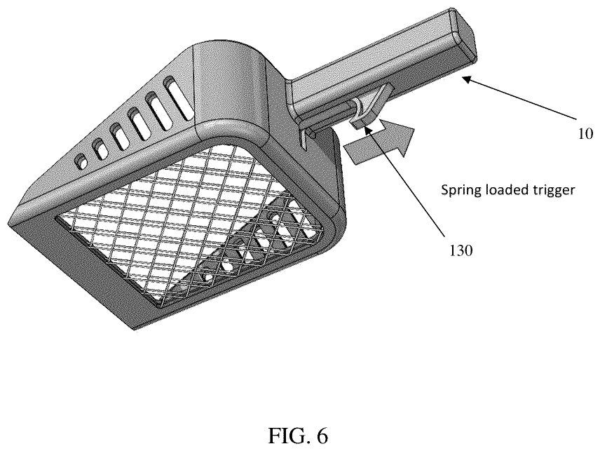

FIG. 7 shows an assembled scoop with a handle having a gripping region.

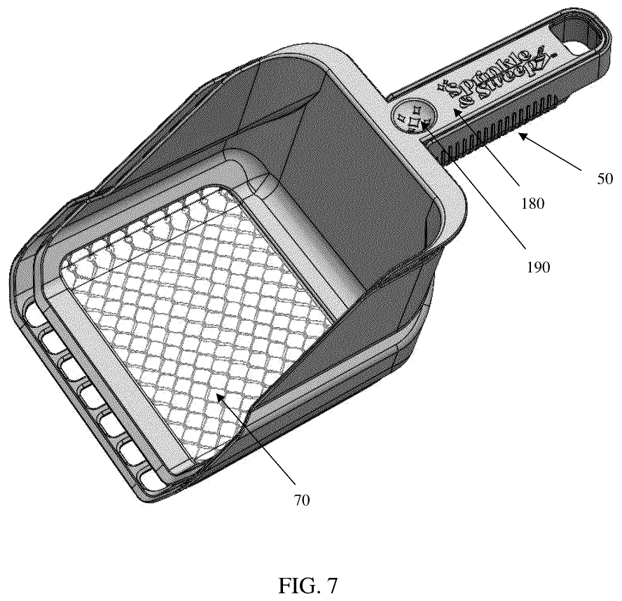

FIG. 8 shows a mesh frame side edge with chamfers.

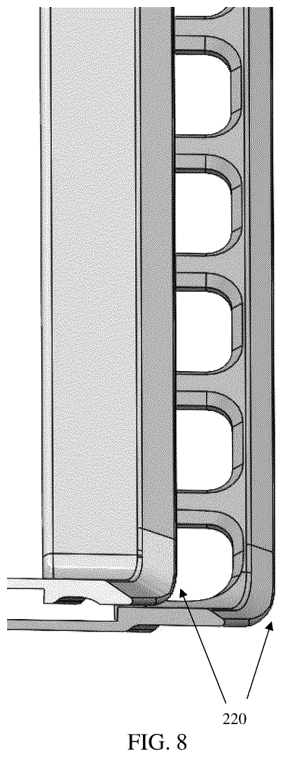

FIG. 9 shows a mesh frame front edge with chamfers.

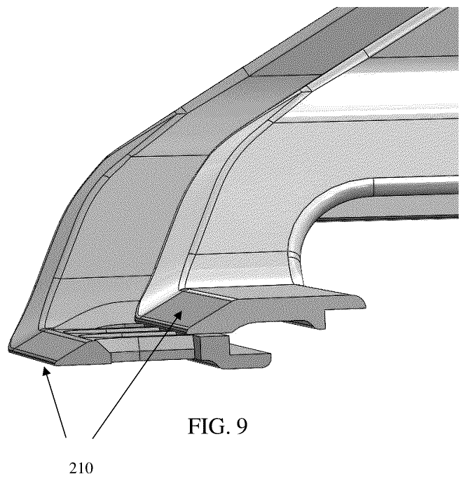

What is claimed:

1. A litter scoop comprising:
a primary outer scoop containing a plurality of openings configured to allow litter to pass through the plurality of openings when the litter scoop is used to collect litter;
a secondary inner scoop containing a plurality of openings configured to allow litter to pass through the plurality of openings when the litter scoop is used to collect litter wherein the secondary scoop is permanently or detachably connected to the primary scoop;
a handle attached to the primary scoop configured to allow the user to grip the scoop when scooping litter;
wherein the resulting plurality of openings present in the scoop when the secondary inner scoop is attached to the primary outer scoop are smaller than those present in either the primary outer scoop or secondary inner scoop individually.

2. The scoop of claim 1 wherein the secondary inner scoop is permanently attached to the primary outer scoop.

3. The scoop of claim 1 wherein the secondary inner scoop is detachably attached to the primary outer scoop.

4. The scoop of claim 1 wherein the scoop handle contains gripping regions to aid user grip on the handle while the scoop is in use.

5. The scoop of claim 1 wherein the plurality of openings in the primary and secondary scoops are formed with molded plastic.

6. The scoop of claim 1 wherein the plurality of openings in the primary and secondary scoops are formed with wire.

7. The scoop of claim 1 wherein the handle of the scoop contains a hole whereby the scoop can be stored by hanging the handle on a hook or peg through the hole.

8. A litter scoop comprising:
a primary outer scoop containing a plurality of openings configured to allow litter to pass through the plurality of openings when the litter scoop is used to collect litter;
a secondary inner scoop containing a plurality of openings configured to allow litter to pass through the plurality of openings when the litter scoop is used to collect litter wherein the secondary scoop is permanently or detachably connected to the primary scoop;
a handle attached to the primary scoop configured to allow the user to grip the scoop when scooping litter;
a spring-loaded trigger attached to the handle wherein the spring-loaded trigger can be actuated by the user to control the size of the size of the resulting openings in the scoop formed by the primary and secondary scoops by protracting and retracting the secondary scoop relative to the primary scoop.

9. The scoop of claim 8 wherein the spring-loaded trigger in the handle of the scoop comprises a trigger, a spring, and a linkage system connecting the spring to the actuatable secondary inner scoop.

10. The scoop of claim 8 wherein the scoop handle contains gripping regions to aid user grip on the handle while the scoop is in use.

11. The scoop of claim 8 wherein the plurality of openings in the primary and secondary scoops are formed with molded plastic.

12. The scoop of claim 8 wherein the plurality of openings in the primary and secondary scoops are formed with wire.

13. The scoop of claim 8 wherein the handle of the scoop contains a hole whereby the scoop can be stored by hanging the handle on a hook or peg through the hole.

14. A litter scoop comprising:
a primary outer scoop containing a plurality of openings configured to allow litter to pass through the plurality of openings when the litter scoop is used to collect litter;
a secondary inner scoop containing a plurality of openings configured to allow litter to pass through the plurality of openings when the litter scoop is used to collect litter wherein the secondary scoop is permanently or detachably connected to the primary scoop;
a handle attached to the primary scoop configured to allow the user to grip the scoop when scooping litter;
an actuatable sliding trigger in the handle of the scoop wherein the operator of the scoop can adjust the size of the plurality of openings in the scoop by engaging the trigger to protract or retract the secondary inner scoop relative to the primary outer scoop.

15. The scoop of claim 14 wherein the front and side edges of the inner and outer scoops contain chamfers.

16. The scoop of claim 14 wherein the scoop handle contains gripping regions to aid user grip on the handle while the scoop is in use.

17. The scoop of claim 14 wherein the scoop handle contains a greppable depression to receive the finger of an operator to improve their grip when actuating the sliding trigger or operating the scoop.

18. The scoop of claim 14 wherein the plurality of openings in the primary and secondary scoops are formed with molded plastic.

19. The scoop of claim 14 wherein the plurality of openings in the primary and secondary scoops are formed with wire.

20. The scoop of claim 14 wherein the front edge of the outer scoop contains a multitude of holes whereby the user can sift litter.
